(19) United States
(12) Patent Application Publication
(10) Pub. No.: US 2023/0136209 A1
(43) Pub. Date: May 4, 2023

(54) UNCERTAINTY ANALYSIS OF EVIDENTIAL DEEP LEARNING NEURAL NETWORKS

(71) Applicant: Intel Corporation, Santa Clara, CA (US)

(72) Inventor: Anthony Rhodes, Portland, OR (US)

(21) Appl. No.: 18/148,138

(22) Filed: Dec. 29, 2022

(51) Int. Cl. G06F 18/21; G06N 3/044

(52) U.S. Cl. CPC G06F 18/217; G06N 3/044

(57) ABSTRACT

Disclosed is an example solution to analyze uncertainty of an evidential deep learning neural network with dissonance regularization and recurrent priors. An example apparatus includes processor circuitry to at least one of instantiate or execute the machine readable instructions to receive a first predicted classification of a first input of an evidential deep learning neural network (EVDL NN), identify a first uncertainty metric associated with the EVDL NN, the first uncertainty metric corresponding to the first input of the EVDL NN, calculate a first dissonance score based on the first uncertainty metric, and when the first dissonance score satisfies a threshold, assign the first predicted classification to the first input.

### FIELD OF THE DISCLOSURE

This disclosure relates generally to neural networks and, more particularly, to analysis of uncertainty of an evidential deep learning neural network with dissonance regularization and recurrent priors.

### BACKGROUND

In recent years, the field of deep learning in artificial intelligence has provided significant value by the extraction of important information out of large data sets. As data continues to be generated at ever increasing rates, the ability to make intelligent decisions based on large sets of data is vital to increase the efficiency of data analysis. Deep learning applications are useful across many industries that have a demand for large amounts of data, such as autonomous driving. The predictions of data-learned models may be calibrated for uncertainty.

### BRIEF DESCRIPTION OF THE DRAWINGS

FIG. 1 is an illustration of an example system to determine uncertainty in a prediction model.

FIG. 2 is a block diagram of example prediction certification circuitry of FIG. 1.

FIGS. 3-5 are example diagrams illustrating prediction distributions.

FIG. 6 illustrates uncertainty metrics for different features of the model framework.

FIG. 7 illustrates an example recurrent prior schematic.

FIG. 8 is an example process flow that may be implemented by the example uncertainty analysis circuitry of FIG. 1.

FIG. 9 is a flowchart representative of example machine readable instructions and/or example operations that may be executed by example processor circuitry to implement the prediction certification circuitry of FIG. 2.

FIG. 10 is a block diagram of an example processing platform including processor circuitry structured to execute the example machine readable instructions and/or the example operations of FIG. 9 to implement the example prediction certification circuitry 114 of FIG. 2.

FIG. 11 is a block diagram of an example implementation of the processor circuitry of FIG. 10.

FIG. 12 is a block diagram of another example implementation of the processor circuitry of FIG. 10.

FIG. 13 is a block diagram of an example software distribution platform (e.g., one or more servers) to distribute software (e.g., software corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

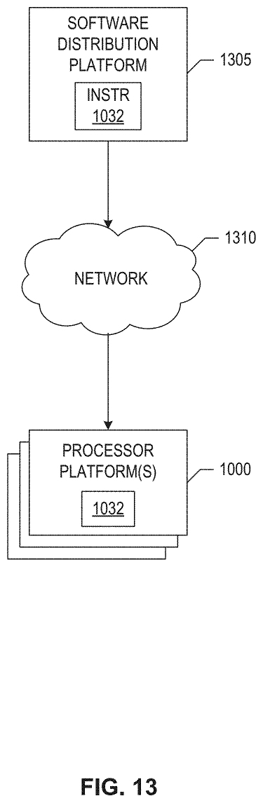

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a Neural Network (NN) model is used. Using a Neural Network (NN) model enables the interpretation of data wherein patterns can be recognized. In general, machine learning models/architectures that are suitable to use in the example approaches disclosed herein will be Convolutional Neural Network (CNN) and/or Deep Neural Network (DNN), wherein interconnections are not visible outside of the model. However, other types of machine learning models could additionally or alternatively be used such as Recurrent Neural Network (RNN), Support Vector Machine (SVM), Gated Recurrent Unit (GRU), Long Short Term Memory (LSTM), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using known vehicle trajectories (e.g., ground truth trajectories). Training is performed using hyperparameters that control how the learning is performed (e.g., a learning rate, a number of layers to be used in the machine learning model, etc.).

Conventional deep learning models often make unreliable predictions, and a measure of uncertainty is not provided in regression tasks with such models. Uncertainty estimation is crucial in particular for safety-critical tasks such as in Autonomous Driving for informed decision making and/or AI assisted medical diagnostics. For a reliable model, the model uncertainty should correlate with its prediction error. Uncertainty calibration is applied to improve the quality of uncertainty estimates, hence more informed decision making is possible on the model prediction during inference. A well-calibrated model results in low uncertainty about its prediction when the model is accurate and indicates high uncertainty when it is likely to be inaccurate. In addition to exhibiting high performance grades (e.g., classification accuracy, classification precision, etc.) on real world data, practical AI systems of the future must furthermore provide nuanced guidance pertaining to the uncertainty of their predictions. Due to the unavailability of ground truth for uncertainty estimates, uncertainty calibration is a challenging problem. Further, uncertainty estimates can be employed for anomaly detection, to improve general model performance, to enhance model calibration properties, to enable higher-order cognitive modeling paradigms (e.g., opinion/belief state formulation, holistic scene understanding, etc.) to trigger human intervention/annotation for human in the loop (HITL) use cases, and to detect data novelty for continuous learning processes.

There are two axes of NN-based uncertainty: (1) uncertainty in the data, i.e., aleatoric uncertainty, and (2) uncertainty in prediction, also known as epistemic uncertainty. The existing approaches to conventional deep learning constrain a model to output predictive class probabilities following the application of a softmax function. In such examples, the softmax output may not render reliable uncertainty estimates because the output represents a point estimate. As such, the existing approaches often fail to capture informative, higher-order structures that embody statistical properties demonstrated at a class and dataset level, including a means to predict out of distribution (OOD) and novel data classes.

Evidential Deep Learning (EDVL) casts learning as an evidence acquisition process. In this way, training examples lend support to a higher-order evidential probability distribution that is directly learned by the model through the prediction of evidential hyperparameters. These high-order evidential distributions as instantiations of distributions from which a dataset is drawn. By training a neural network to predict the hyperparameters governing this higher-order evidential distribution, it is possible to generate representations of epistemic and aleatoric uncertainty in a computationally efficient way, in the absence of additional sampling procedures or ensembling. EVDL can be applied to classification or regression applications. In classification applications, the family of distributions commonly used for this purpose is the Dirichlet distribution. As used herein, a Dirichlet distribution is a multivariate generalization of the Beta distribution and is utilized in multi-class classification applications. The example Dirichlet distribution includes useful mathematical properties (e.g., conjugacy properties). Example equation 1, described in detail below, represents an example Dirichlet distribution calculation.

$$Dir ( μ ; α ) = \frac{1}{β ( α )} {\prod }_{k = 1}^{K} {μ}_{k}^{{α}_{k} - 1} ; β ( α ) = \frac{{\prod }_{k = 1}^{K} Γ ( {α}_{k} )}{Γ ( {α}_{0} )} \qquad ( 1 )$$

In example equation 1 above, Γ(⋅) denotes the gamma function, K is the number of classes, and β(⋅) is the beta function. In an example Dirichlet distribution, each μᵢϵ[0,1], as each variable in the Dirichlet distribution can be considered a Beta random variable on its own. Further, an example continuity constraint is represented in example equation 2 below.

Σᵢ₌₁^{K}μᵢ=1 (2)

In some examples, a strength quantity can be utilized in the example Dirichlet distribution. Examples equation 3, described in detail below, represents an example strength calculation.

α₀=Σₖ₌₁^{K}αₖ (3)

In example equation 3 above, α₀ is a sum of the Dirichlet alpha parameters. As such, α₀ captures the peakedness of the Dirichlet distribution. As used herein, “peakedness” refers to a strength of an example Dirichlet distribution. In some examples, a high α₀ indicates high peakedness and a low α₀ indicates low peakedness.

EVDL can also produce uncertainty measures from DL models through the prediction of parameters from an evidential probability distribution that captures the high-order statistical structure of a sample of point estimates. However, EVDL is susceptible to model performance degradation when maintaining both predictive performance and uncertainty estimation calculations.

Examples disclosed herein improve performance of EVDL using dissonance regularization and recurrent priors. In particular, examples of dissonance regularization disclosed herein employ an additional learning constraint via a loss function to enforce the minimization of conflicting Dirichlet beliefs during model training and increase the decision boundary margin for evidential data embeddings. Examples of dissonance regularization disclosed herein improve the predictive performance of EVDL models while providing uncertainty estimates (e.g., metrics, measurements, etc.). Examples of recurrent priors disclosed herein utilize the conjugacy properties of the Dirichlet distribution and iterative class predictions to encode an example Dirichlet distribution. Examples disclosed herein improve the predictive performance and uncertainty estimates for an example EVDL algorithm with respect to dissonance and vacuity metrics.

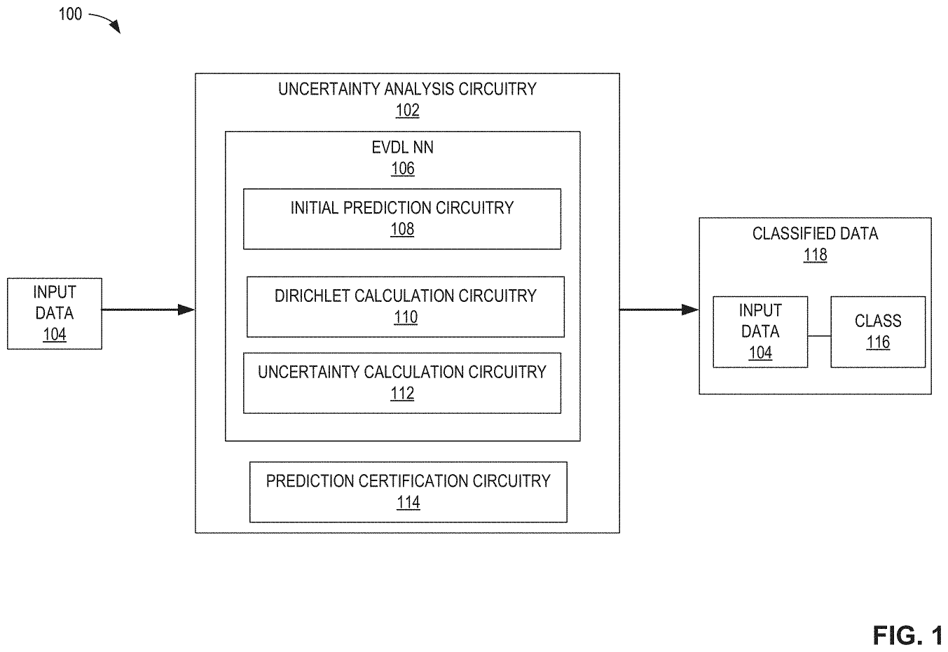

FIG. 1 is an illustration of an example system 100 to analyze (e.g., verify, certify, etc.) uncertainty estimates from a prediction model such as an example EVDL NN 106 shown here. The example system 100 includes example uncertainty analysis circuitry 102. The example uncertainty analysis circuitry 102 receives (e.g., obtains) input data 104 so that the example EVDL NN 106 can determine (e.g., produce, calculate, etc.) initial uncertainty estimates for the model predictions (e.g., classification predictions). In the example of FIG. 1, the EVDL NN 106 includes initial prediction circuitry 108, example Dirichlet calculation circuitry 110, and example uncertainty calculation circuitry 112.

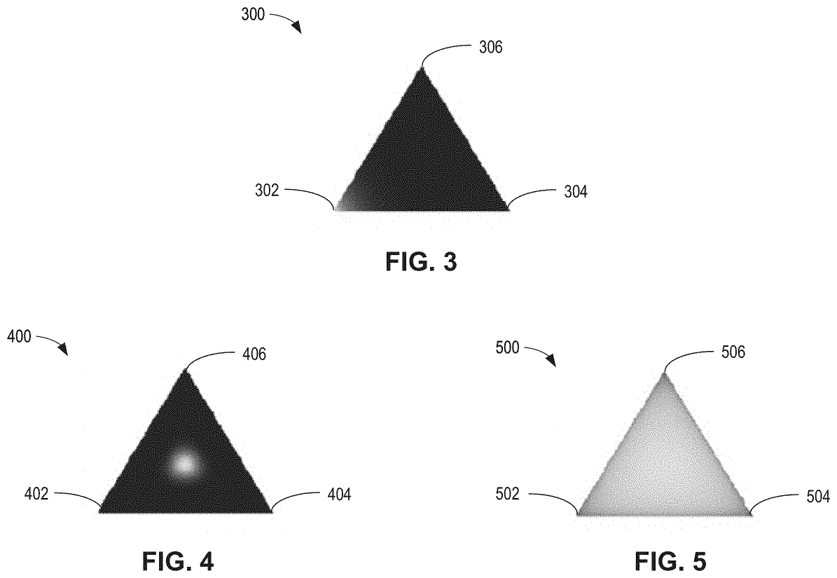

The example initial prediction circuitry 108 predicts classifications for the data 104. For example, the initial prediction circuitry 108 determines first evidence for the ground-truth label class (e.g., a first class prediction) and second evidence for other class assignments (e.g., a second class prediction, a third class prediction, etc.). As such, the example initial prediction circuitry 108 can determine evidence (e.g., data) that supports a first class prediction and evidence that supports a second class prediction. In some examples, the evidence for the first class prediction can be compared to the evidence for the second class prediction to determine whether the first or the second class prediction is a confident prediction. In some examples, the example initial prediction circuitry 108 can determine evidence for class predictions utilizing Equation (8), described in detail below in connection with FIG. 3. As used herein, “evidence” refers to a quantity that indicates support (e.g., trust, confidence, etc.) of a prediction made by a EVDL NN. In some examples, a trustworthy (e.g., confident) prediction will have greater evidence than an untrustworthy prediction. Thus, first evidence associated with a first class prediction can be greater than second evidence associated with a second class prediction.

The example Dirichlet calculation circuitry 110 calculates Dirichlet distributions based on the predicted classifications. For example, the Dirichlet calculation circuitry 110 determines the statistical structure of the data 104. The example uncertainty calculation circuitry 112 determines uncertainty metrics (e.g., scores, OOD predictions, etc.) based on the Dirichlet distributions. In some examples, the EVDL NN 106 utilizes a mean square error (MSE) function to determine uncertainty metrics, which is described in detail in connection with FIGS. 3-5.

In FIG. 1, the EVDL NN 106 determines (e.g., outputs) uncertainty estimates that indicate a strength of the predicted classification. For example, the EVDL NN 106 outputs hyperparameter estimates of evidential Dirichlet distributions that indicate a higher-order statistical structure of a sample of point estimates. The example uncertainty analysis circuitry 102 includes example prediction certification circuitry 114 to verify the uncertainty estimates determined by the EVDL NN 106. In other words, the example prediction certification circuitry 114 can identify OOD and novel data included in the input data 104. For example, the example prediction certification circuitry 114 can quantify degrees of predictive uncertainty based on the determined uncertainty metrics. Accordingly, the example prediction certification circuitry 114 determines the strength (e.g., accuracy, correctness, etc.) of a predicted classification 116 from the EVDL NN 106 such that the input data 104 is assigned to the predicted classification 116. In turn, the uncertainty analysis circuitry 102 determines classified data 118, the classified data 118 including the input data 104 and the predicted classification 116.

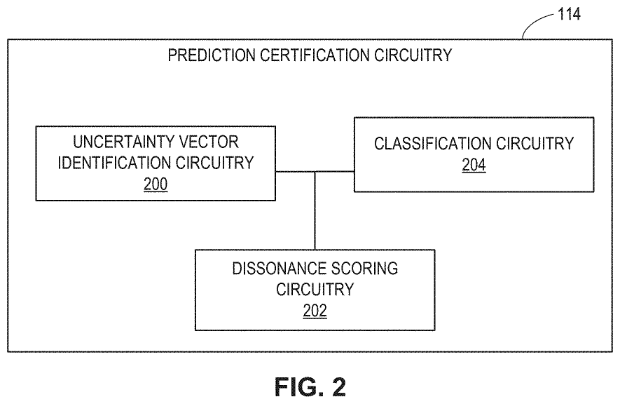

Examples disclosed herein are described with manufacturing processes as example real-world applications of the system 100 and, more particularly, the uncertainty analysis circuitry 102. However, examples disclosed herein are not limited thereto. An example implementation of the prediction certification circuitry is described below in connection with FIG. 2.

FIG. 2 is a block diagram of the example prediction certification circuitry 114 to verify predicted classifications of an EVDL NN. The example prediction certification circuitry 114 of FIG. 2 may be instantiated (e.g., creating an instance of, bring into being for any length of time, materialize, implement, etc.) by processor circuitry such as a central processing unit executing instructions. Additionally or alternatively, the prediction certification circuitry 114 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

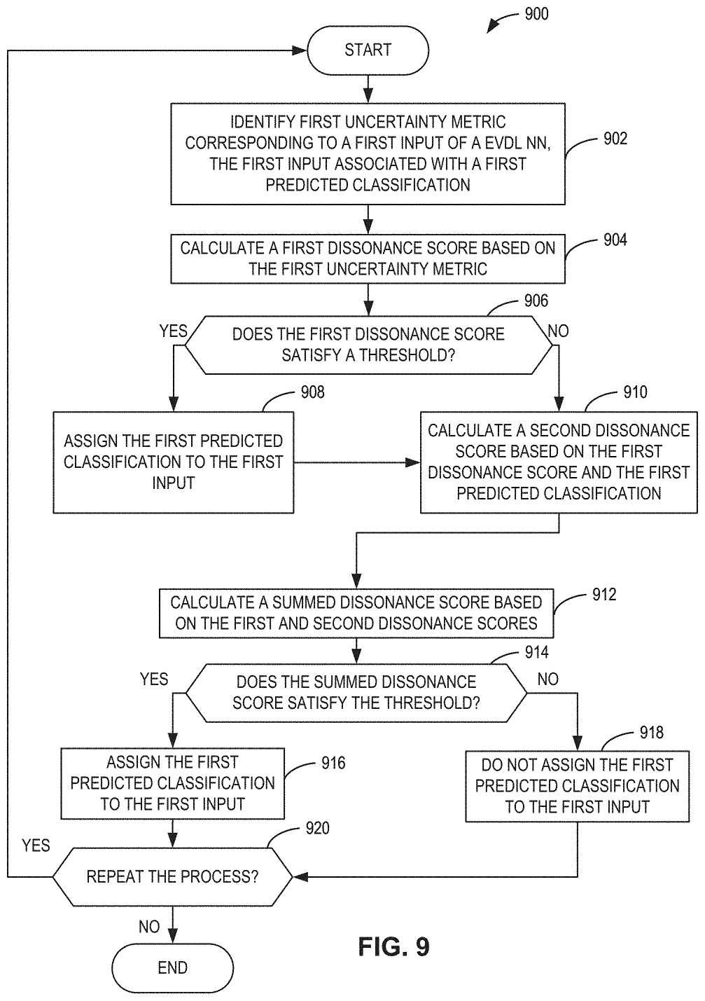

The example prediction certification circuitry 114 includes example uncertainty vector identification circuitry 200, example dissonance scoring circuitry 202, and example classification circuitry 204. The example uncertainty vector identification circuitry 200 identifies uncertainty metrics associated with the EVDL NN 106. For example, the uncertainty vector identification circuitry 200 can identify an uncertainty metric corresponding to a first input (e.g., a first input of the input 104). Further, the example uncertainty vector identification circuitry 200 identifies (e.g., receives) predicted classifications associated with the input 104. For example, if the input data 104 is a video of a manufacturing process, then the uncertainty vector identification circuitry 200 can identify predicted classifications associated with each frame of the input data 104. In some examples, the predicted classifications of a manufacturing process can include motions (e.g., actions) of the human executing the process, positions of the objects in the manufacturing process, movements of the tools in the manufacturing process, etc. In some examples, a first frame of the input data can be associated with a first predicted classification of a first action and a second frame of the input data can be associated with a second predicted classification. In such examples, the first action is different from the second action such that the first predicted classification is different from the second predicted classification. As such, the example uncertainty vector identification circuitry 200 can identify different predicted classifications from the input data 104. In some examples, the example EVDL NN 106 determines a predicted classification associated with a first input of the input data 104. In some examples, the uncertainty vector identification circuitry 200 identifies uncertainty metrics that are represented by Dirichlet distribution. In some examples, the uncertainty vector identification circuitry 200 is instantiated by processor circuitry executing uncertainty vector identification instructions and/or configured to perform operations such as those represented by the flowchart of FIG. 9.

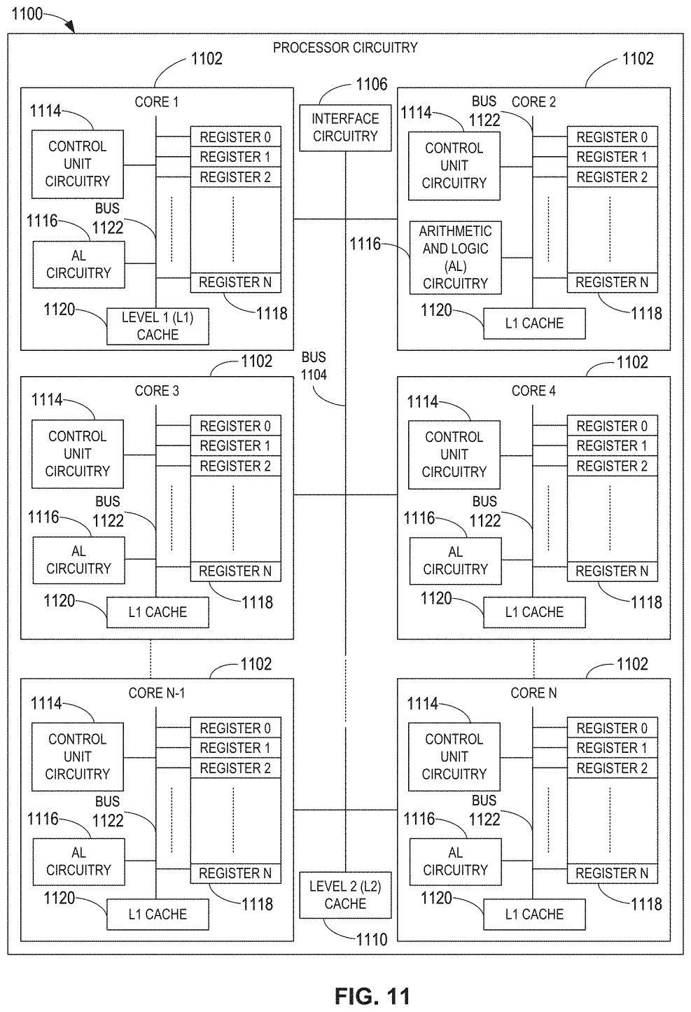

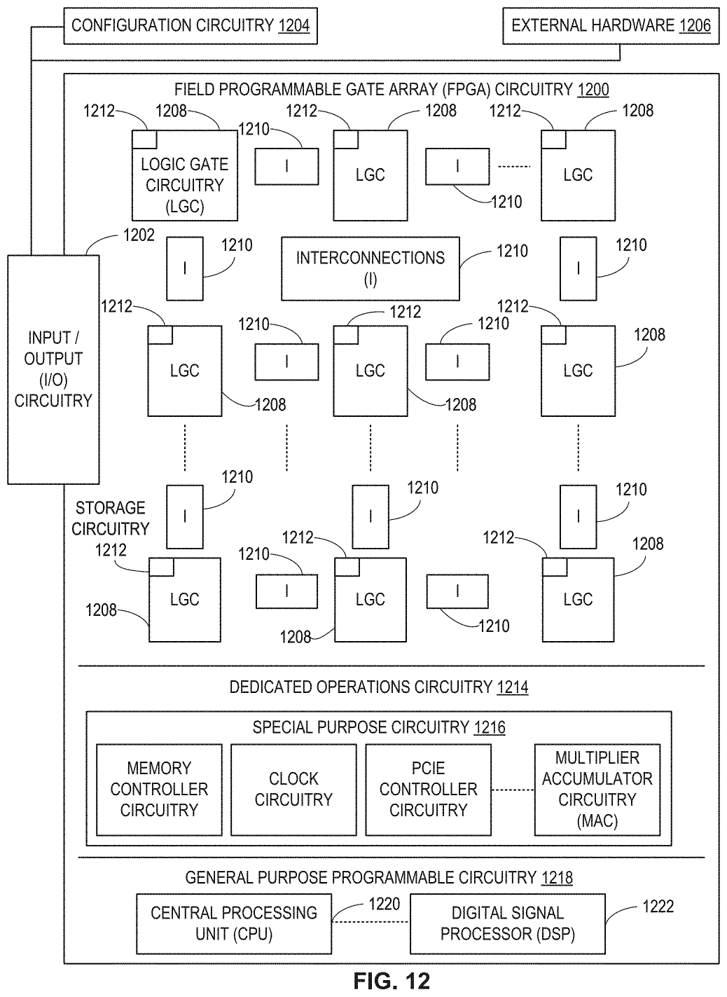

In some examples, the prediction certification circuitry 114 includes means for identifying uncertainty metrics. For example, the means for identifying may be implemented by uncertainty vector identification circuitry 200. In some examples, the uncertainty vector identification circuitry 200 may be instantiated by processor circuitry such as the example processor circuitry 1012 of FIG. 104. For instance, the uncertainty vector identification circuitry 200 may be instantiated by the example microprocessor 1100 of FIG. 11 executing machine executable instructions such as those implemented by at least blocks 902 of FIG. 9. In some examples, uncertainty vector identification circuitry 200 may be instantiated by hardware logic circuitry, which may be implemented by an ASIC, XPU, or the FPGA circuitry 1200 of FIG. 12 structured to perform operations corresponding to the machine readable instructions. Additionally or alternatively, the uncertainty vector identification circuitry 200 may be instantiated by any other combination of hardware, software, and/or firmware. For example, the uncertainty vector identification circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example dissonance scoring circuitry 202 determines dissonance scores based on the uncertainty metrics. In some examples, the dissonance scoring circuitry 202 can determine dissonance scores based on prior ones of the dissonance scores and the predicted classification. In some examples, the dissonance scoring circuitry 202 can determine a summed dissonance score based on prior ones of the dissonance scores. In some examples, the dissonance scoring circuitry 202 can calculate a dissonance score that includes a value between 0 and 1. In some examples, the dissonance scoring circuitry 202 is instantiated by processor circuitry executing dissonance scoring instructions and/or configured to perform operations such as those represented by the flowchart of FIG. 9.

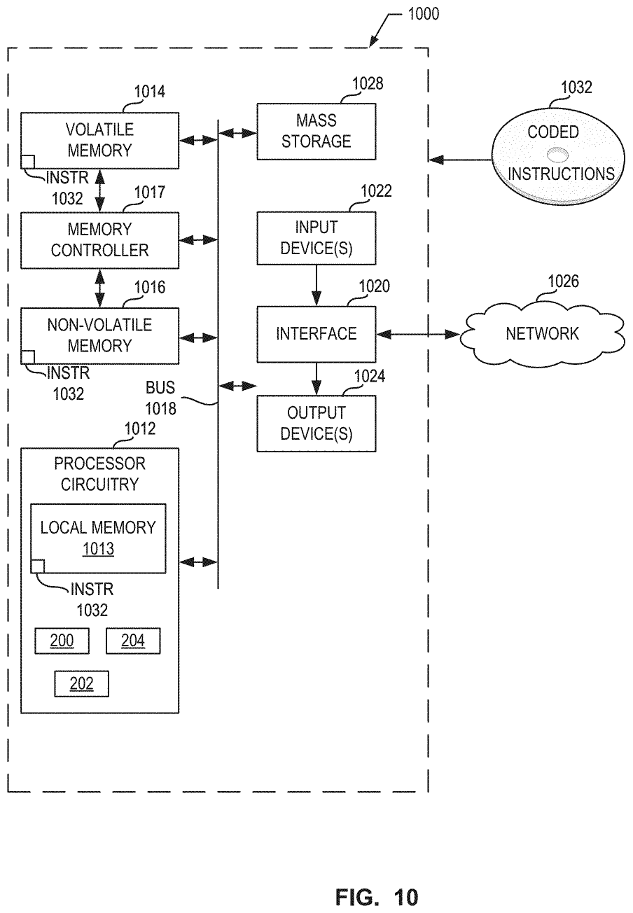

In some examples, the prediction certification circuitry 114 includes means for calculating a dissonance score. For example, the means for calculating may be implemented by dissonance scoring circuitry 202. In some examples, the dissonance scoring circuitry 202 may be instantiated by processor circuitry such as the example processor circuitry 1012 of FIG. 10. For instance, the dissonance scoring circuitry 202 may be instantiated by the example microprocessor 1100 of FIG. 11 executing machine executable instructions such as those implemented by at least blocks 904, 910, 912 of FIG. 9. In some examples, dissonance scoring circuitry 202 may be instantiated by hardware logic circuitry, which may be implemented by an ASIC, XPU, or the FPGA circuitry 1200 of FIG. 12 structured to perform operations corresponding to the machine readable instructions. Additionally or alternatively, the dissonance scoring circuitry 202 may be instantiated by any other combination of hardware, software, and/or firmware. For example, the dissonance scoring circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example classification circuitry 204 determines whether an example dissonance score satisfies a threshold. In some examples, the classification circuitry 204 compares an example dissonance score to a threshold. In some examples, when the example dissonance score satisfies a threshold, the classification circuitry 204 assigns the predicted classification to the first input of the input data 104. For example, the classification circuitry 204 can determine that an example dissonance score satisfies a threshold when the dissonance score is less than 0.1. In other words, when the example dissonance score is lower than an example threshold (e.g., 0.1, 0.2, etc.), the classification circuitry 204 determines that the predicted classification (e.g., the predicted classification 116) is an accurate prediction.

Accordingly, the example classification circuitry 204 assigns the predicted classification 116 to the input data 104. In other examples, when the example dissonance score exceeds a threshold, the classification circuitry 204 does not assign the predicted classification to the first input of the input data. For example, the classification circuitry 204 can determine that an example dissonance score exceeds a threshold with the dissonance score is greater than 0.1 (e.g., 0.2, 0.3, etc.). As such, when the example dissonance score is greater than the example threshold, the classification circuitry 204 can determine that the predicted classification (e.g., the predicted classification 116) is an inaccurate prediction. Accordingly, the example classification circuitry 204 may not assign the predicted classification 116 to the input data 104. In some examples, the classification circuitry 204 is instantiated by processor circuitry executing classification instructions and/or configured to perform operations such as those represented by the flowchart of FIG. 9.

In some examples, the prediction certification circuitry 114 includes means for assigning predicted classifications. For example, the means for assigning may be implemented by classification circuitry 204. In some examples, the classification circuitry 204 may be instantiated by processor circuitry such as the example processor circuitry 1012 of FIG. 10. For instance, the classification circuitry 204 may be instantiated by the example microprocessor 1100 of FIG. 11 executing machine executable instructions such as those implemented by at least blocks 906, 908, 914, 916, 918, 920 of FIG. 9. In some examples, classification circuitry 204 may be instantiated by hardware logic circuitry, which may be implemented by an ASIC, XPU, or the FPGA circuitry 1200 of FIG. 12 structured to perform operations corresponding to the machine readable instructions. Additionally or alternatively, the classification circuitry 204 may be instantiated by any other combination of hardware, software, and/or firmware. For example, the classification circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

FIGS. 3-5 are example diagrams 300, 400, 500 illustrating Dirichlet distributions for predicted classifications. Each of the example diagrams 300, 400, 500 visually represent how certain the EVDL NN 106 is that a predicted classification is an accurate prediction. For example, the example EVDL NN 106 can determine a predicted classification for a first input of the input data 104 via the initial prediction circuitry 108. In turn, the example Dirichlet calculation circuitry 110 can generate the diagrams 300, 400, 500 to indicate the confidence (e.g., trustworthiness) in that predicted classification. In some examples, the diagrams 300, 400, 500 are referred to as simplexes. In each of the example diagrams 300, 400, 500, there are three vertices representing three example classifications determined by the EVDL NN 106. In other examples, an example simplex can have two vertices representing two example classifications. Further, the example diagrams 300, 400, 500 include shaded regions and unshaded regions, wherein the unshaded regions indicate the uncertainty of the predictions of the EVDL NN 106.

Turning to FIG. 3, the example diagram 300 includes example classifications 302, 304, 306. The example diagram 300 includes an unshaded region and a shaded region. The example unshaded region is positioned near the classification 302. As such, the Dirichlet distribution associated with diagram 300 indicates that the classification 302 is a confident prediction. Accordingly, the dissonance score associated with the diagram 300 can satisfy the example threshold of 0.1. For example, the dissonance score associated with the diagram 300 can be 0, 0.05, etc. In some examples, the predicted classification associated with the diagram 300 be referred to as a confident prediction.

Turning the FIG. 4, the example diagram 400 includes example classifications 402, 404, 406. The example diagram 400 includes an unshaded region and a shaded region. The example unshaded region is positioned approximately equidistant from the classifications 402, 404, 406. As such, the Dirichlet distribution associated with diagram 300 indicates a lack of confidence in the prediction because there is a lack of proximity to any of the classifications 402, 404, 406. Accordingly, the dissonance score associated with the diagram 400 can exceed the example threshold of 0.1. For example, the dissonance score associated with the diagram 400 can be 0.8, 0.98, etc. In some examples, the predicted classification associated with the diagram 400 be referred to as a conflicted prediction.

Turning the FIG. 5, the example diagram 500 includes example classifications 502, 504, 506. The example diagram 500 includes an unshaded region that cover each of the classifications 502, 504, 506. As such, the Dirichlet distribution associated with diagram 500 indicates an OOD prediction. In some examples, the dissonance score associated with the diagram 500 may satisfy the threshold of 0.1, but the vacuity associated with the diagram 500 can indicated that the prediction is OOD and, therefore, unreliable. As used herein, “vacuity” refers to a lack of evidence. In some examples, the predicted classification associated with the diagram 500 be referred to as an OOD prediction. In some other examples, additional parameters such as aleatoric uncertainty, epistemic uncertainty and entropy can as be utilized to describe the diagrams 300, 400, 500.

The example Dirichlet distributions associated with the diagrams 300, 400, 500 can be determined by equations 1, 2, and 3, as described above. Example equations 4, 5, and 6, described in detail below, represents predicted concentration parameters associated with the Dirichlet distributions.

$$α = {f}_{θ} ( x ) \qquad ( 4 )$$

$${μ}_{k} = \frac{{α}_{k}}{{α}_{0}} \qquad ( 5 )$$

$$\hat{y} = arg max {μ}_{1} , … , {μ}_{K} \qquad ( 6 )$$

In the example equations 5 and 6 above, k denotes a number of the classifications (e.g., the classifications 302, 304, 306, dimensions, etc.). In some examples, for K classifications, a neural classifier is realized as a function mapping data points to k-dimensional logits. In some examples, a NN architecture can be adapted to predict hyperparamters of Dirichlet distributions, without any major modifications. For example, in order to classify a datapoint x, a categorical distribution is created from the predicted concentration parameters of the Dirichlet based on the equations 4, 5, and 6. In the example equation 4 above, f_{θ}(x) represents the logit output of the model parameterized by θ, with respect to the input datum x.

Example equation 7, described in detail below, represents a means square error (MSE) formulation. In some examples, EVDL NNs are trained using the MSE formulation.

$$L ( {θ}_{i} ) = \int {‖ {y}_{i} - {μ}_{i} ‖}_{2}^{2} \frac{1}{β ( α )} {\prod }_{k = 1}^{K} {μ}_{ik}^{{α}_{ik - 1}} d {μ}_{i} = \qquad ( 7 )$$

$${\sum }_{k = 1}^{K} {( {y}_{ik} - {\hat{μ}}_{ik} )}^{2} + \frac{{\hat{μ}}_{ik} ( 1 - {\hat{μ}}_{ik} )}{{α}_{i 0}}$$

Example equation 8, described in detail below, represents an evidence vector produced by the EVDL NN 106.

e=RELU(f_{θ}(x)) (8)

In example equation 8 above, θ represents parameters for the input datum x. Further, (f_{θ}(x)) is the output logit and e is the result of applying RELU to this output logit, where e is a k-dimensional evidence vector such that each evidence component is non-negative.

Example equations 8, 9, 10, described in detail below, represents uncertainty mass associated with the predictive uncertainty determined by the evidence generated by the example EVDL NN 106.

$$u + {\sum }_{k = 1}^{K} {b}_{k} = 1 \qquad ( 8 )$$

$${b}_{k} = \frac{{e}_{k}}{S} , where S = {\sum }_{i = 1}^{K} ( {e}_{i} + 1 ) \qquad ( 9 )$$

$$u = \frac{K}{S} \qquad ( 10 )$$

In example equation 10 above, u is the uncertainty (e.g., uncertainty metric). In some examples, u is referred to as the predictive vacuity of the model for the input datum x. Thus, vacuity can represent a lack of evidence cause by insufficient information or knowledge to understand or analyze a given opinion.

Example equation 11, described in detail below, represents a dissonance calculation (e.g., dissonance score).

$$diss ( b ) = {\sum }_{i = 1}^{K} \frac{{b}_{i} {\sum }_{j \neq i} Bal ( {b}_{j} , {b}_{i} )}{{\sum }_{j \neq i} {b}_{j}} , where Bal ( {b}_{j} , {b}_{i} ) = 1 - \frac{\vert {b}_{j} - {b}_{i} \vert}{{b}_{j} + {b}_{i}} \qquad ( 11 )$$

Example equation 12, described in detail below, represents an example dissonance regularization calculation.

$$L ( {θ}_{i} ) = {\sum }_{k = 1}^{K} {( {y}_{ik} - {\hat{μ}}_{ik} )}^{2} + \frac{{\hat{μ}}_{ik} ( 1 - {\hat{μ}}_{ik} )}{{α}_{i 0}} + λ {\sum }_{i = 1}^{K} \frac{{b}_{i} {\sum }_{j \neq i} Bal ( {b}_{j} , {b}_{i} )}{{\sum }_{j \neq i} {b}_{j}} \qquad ( 12 )$$

In example equation 12 above, A is a hyper parameter indicating the dissonance of a predicted classification based on the EVDL NN 106.

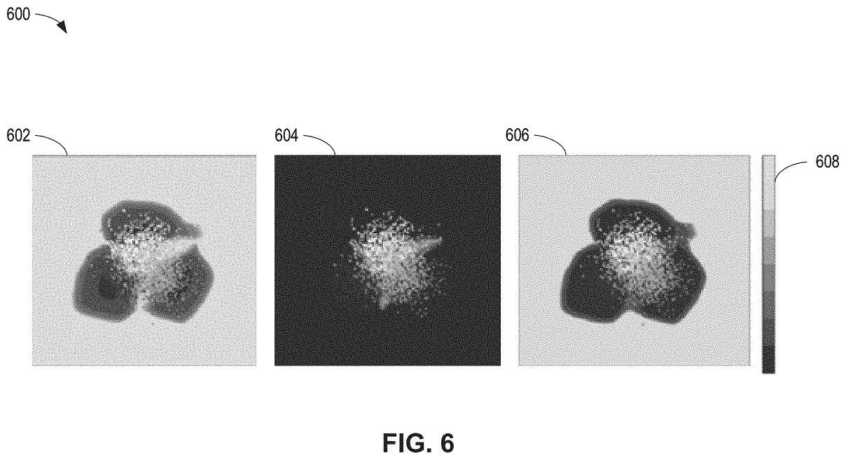

FIG. 6 illustrates uncertainty metrics for different features of the EVDL NN. For example, example plots 602, 604, 606 can indicate uncertainty metrics according to an example uncertainty scale 608. For example, the plot 602 can correspond to an entropy parameter, plot 604 can correspond to a dissonance parameter, and plot 606 can correspond to a vacuity parameter.

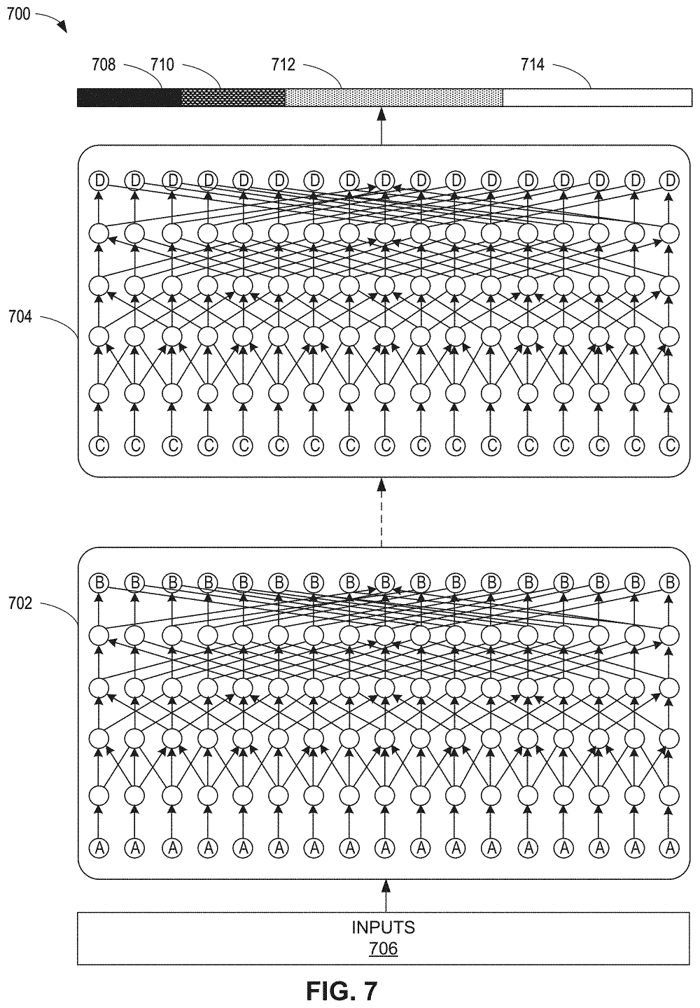

FIG. 7 illustrates an example recurrent prior schematic 700. The example schematic 700 illustrates a multi-stage temporal convolutional network (TCN) as an example EVDL model. In some examples, the schematic 700 is representative of a recurrent model. The example schematic 700 includes a first stage 702 and an nth stage 704, for a total of N stages. The first example stage 702 receives inputs 706 and determines first predicted classifications (shown in FIG. 7 as “B”) via a serious of layers. The nth stage 704 receives the first predicted classifications B as inputs, and determines second predicted classifications (shown in FIG. 7 as “D”) via a serious of layers. As shown in FIG. 7, each of the second predicted classifications D can be assigned to any of classifications 708, 710, 712, 714. In some examples, the prediction certification circuitry 114 can assign the classifications 708, 710, 712, 714. In FIG. 7, the schematic 700 represents an intermediate classification prediction logit such that, in subsequent stages, predictions are refined iteratively. In some examples, the predicted classifications in FIG. 7 are referred to a pseudo data observations rendered by a categorical prior. Example equation 13, described in detail below, represents an evidence vector defined with respect to the pseudo data observations.

e=RELU(f_{θ}(x))+Σᵢ₌₁^{N}f_{σ}_{ᵢ}₍ₓ₎ (13)

In equation 13 above, f_{θ}(x) denotes the final stage evidential prediction and f_{θ}_{ᵢ}₍ₓ₎ denotes the ith stage evidential prediction.

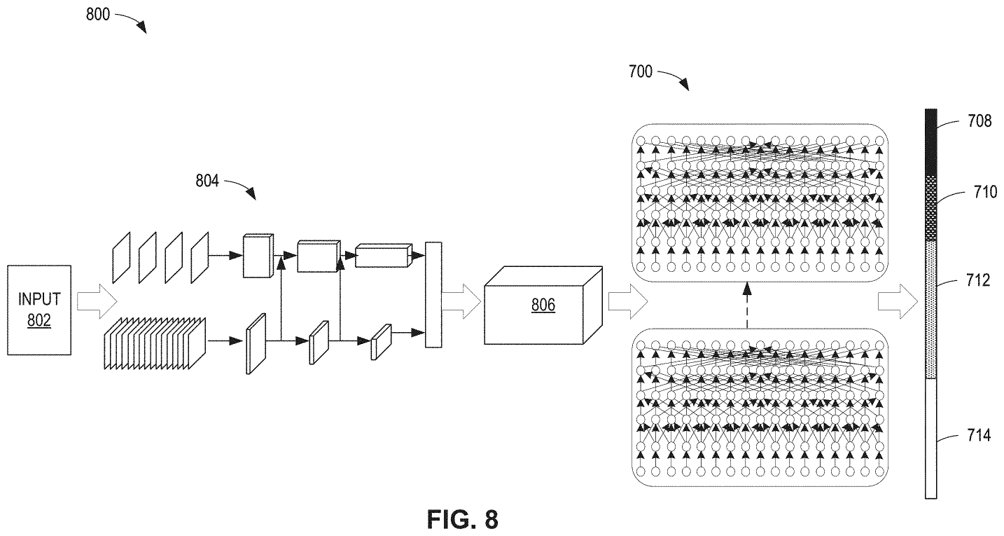

FIG. 8 is an example process flow 800 that may be implemented by the example uncertainty analysis circuitry of FIG. 1. The example process flow 800 begins at data input 802. In some examples, the data input 802 can include video data (e.g., video clips, video frames, etc.) of an example manufacturing process. In the example of FIG. 8, the data input 802 includes 13 classifications (e.g., 13 actions, 13 motions, etc.). Next, the process flow 800 proceeds to step 804 where frame-wise features are extracted from the raw video data, for example. At step 806, the frame-wise classifications are determined and passed to the schematic 700 of FIG. 7. As such, the frame-wise classifications are received as inputs to the example schematic 700. After the iterative processing at the schematic 700 of FIG. 7, frame-wise classifications are determined as any of the predicted classifications 708, 710, 712, 714. Thus, the frames (e.g., raw data) included the data input 802 is assigned to the predicted classifications 708, 710, 712, 714.

While an example manner of implementing the prediction certification circuitry 114 of FIG. 1 is illustrated in FIG. 2, one or more of the elements, processes, and/or devices illustrated in FIG. 2 may be combined, divided, re-arranged, omitted, eliminated, and/or implemented in any other way. Further, the example uncertainty vector identification circuitry 200, the example dissonance scoring circuitry 202, the example classification circuitry 204 and/or, more generally, the example prediction certification circuitry 114 of FIG. 1, may be implemented by hardware alone or by hardware in combination with software and/or firmware. Thus, for example, any of the example uncertainty vector identification circuitry 200, the example dissonance scoring circuitry 202, the example classification circuitry 204, and/or, more generally, the example prediction certification circuitry 114, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example prediction certification circuitry 114 of FIG. 1 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed to configure processor circuitry to implement the prediction certification circuitry 114 of FIG. 2, is shown in FIG. 9. The machine readable instructions may be one or more executable programs or portion(s) of an executable program for execution by processor circuitry, such as the processor circuitry 1012 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 9, many other methods of implementing the example prediction certification circuitry 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by processor circuitry to verify the uncertainty estimates determined by the EVDL NN 106. The machine readable instructions and/or the operations 900 of FIG. 9 begin at block 902, at which the uncertainty vector circuitry 200 identifies a first uncertainty metric corresponding to a first input of the EVDL NN 106. In some examples, the first input is associated with a first predicted classification. For example, if the input data 104 is a video of a manufacturing process, then the uncertainty vector identification circuitry 200 can identify predicted classifications associated with each frame of the input data 104. In some examples, the predicted classifications of a manufacturing process can include motions (e.g., actions) of the human executing the process, positions of the objects in the manufacturing process, movements of the tools in the manufacturing process, etc. In some examples, the example EVDL NN 106 determines a predicted classification associated with a first input of the input data 104. In some examples, the uncertainty vector identification circuitry 200 identifies uncertainty metrics that are represented by Dirichlet distribution.

At block 904, the example dissonance scoring circuitry 202 calculates a first dissonance score based on the first uncertainty metric. In some examples, the dissonance scoring circuitry 202 can calculate a dissonance score that includes a value between 0 and 1.

At block 906, the example classification circuitry 204 determines whether the example dissonance score satisfies a threshold. For example, a dissonance score can satisfy the threshold when the example dissonance score is less than 0.1. Alternatively, a dissonance score can exceed the threshold when the example dissonance score is greater than 0.1. If the example dissonance score satisfies the threshold, the process proceeds to block 908. Otherwise, the process proceeds to block 910.

At block 908, the example classification circuitry 204 assigns the first predicted classification to the first input.

At block 910, the example dissonance scoring circuitry 202 calculates a second dissonance score based on the first dissonance score and the first predicted classification. For example, the example schematic 700 utilizes multiple stages 702, 704 to generate predicted classifications based on prior ones of the predicted classifications.

At block 912, the example dissonance scoring circuitry 202 calculates a summed dissonance score based on the first and second dissonance score.

At block 914, the example classification circuitry 204 determines whether the summed dissonance score satisfies the threshold. For example, a summed dissonance score can satisfy the threshold when the example dissonance score is less than 0.1. Alternatively, a summed dissonance score can exceed the threshold when the example dissonance score is greater than 0.1. If the example summed dissonance score satisfies the threshold, the process proceeds to block 916. Otherwise, the process proceeds to block 918.

At block 916, the example classification circuitry 204 assigns the first predicted classification to the first input (e.g., the classified data 118).

At block 918, the example classification circuitry 204 does not assign the first predicted classification to the first input.

At block 920, the example classification circuitry 204 determines whether to repeat the process. Otherwise the process ends.

FIG. 10 is a block diagram of an example processor platform 4000 structured to execute and/or instantiate the machine readable instructions and/or the operations of FIG. 9 to implement the prediction certification circuitry 114 of FIG. 1. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example uncertainty vector identification circuitry 200, example dissonance scoring circuitry 202, and example classification circuitry 204.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIG. 9 may be stored in the mass storage device 1028, in the volatile memory 1014, in the non-volatile memory 1016, and/or on a removable non-transitory computer readable storage medium such as a CD or DVD.

FIG. 11 is a block diagram of an example implementation of the processor circuitry 1012 of FIG. 10. In this example, the processor circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowchart of FIG. 9 to effectively instantiate the prediction certification circuitry 114 of FIG. 2 as logic circuits to perform the operations corresponding to those machine readable instructions. In some such examples, the prediction certification circuitry 114 of FIG. 2 is instantiated by the hardware circuits of the microprocessor 1100 in combination with the instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowchart of FIG. 9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 12 is a block diagram of another example implementation of the processor circuitry 1012 of FIG. 10. In this example, the processor circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowchart of FIG. 9 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowchart of FIG. 9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 9. As such, the FPGA circuitry 1200 may be structured to effectively instantiate some or all of the machine readable instructions of the flowchart of FIG. 9 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIG. 9 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may be implemented by external hardware circuitry. For example, the external hardware 1206 may be implemented by the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations that may correspond to at least some of the machine readable instructions of FIG. 9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowchart of FIG. 9 may be executed by one or more of the cores 1102 of FIG. 11, a second portion of the machine readable instructions represented by the flowchart of FIG. 9 may be executed by the FPGA circuitry 1200 of FIG. 12, and/or a third portion of the machine readable instructions represented by the flowchart of FIG. 9 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

A block diagram illustrating an example software distribution platform 1305 to distribute software such as the example machine readable instructions 1032 of FIG. 10 to hardware devices owned and/or operated by third parties is illustrated in FIG. 10. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions 900 of FIG. 9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions 900 of FIG. 9, may be downloaded to the example processor platform 1000, which is to execute the machine readable instructions 1032. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices.

From the foregoing, it will be appreciated that example systems, methods, apparatus, and articles of manufacture have been disclosed that improve performance of EVDL using dissonance regularization and recurrent priors. Examples disclosed herein improve the predictive performance of EVDL models while providing uncertainty estimates (e.g., metrics, measurements, etc.). Examples disclosed herein utilize the conjugacy properties of the Dirichlet distribution and iterative class predication to encode an example Dirichlet distribution. Examples disclosed herein improve the predictive performance and uncertainty estimates for an example EVDL algorithm with respect to dissonance and vacuity metrics. Disclosed systems, methods, apparatus, and articles of manufacture improve the efficiency of using a computing device by employing an additional learning constraint via a loss function to enforce the minimization of conflicting Dirichlet beliefs during model training and increase the decision boundary margin for evidential data embeddings. Disclosed systems, methods, apparatus, and articles of manufacture are accordingly directed to one or more improvement(s) in the operation of a machine such as a computer or other electronic and/or mechanical device.

Example 1 includes an apparatus comprising at least one memory, machine readable instructions, and processor circuitry to at least one of instantiate or execute the machine readable instructions to receive a first predicted classification of a first input of an evidential deep learning neural network (EVDL NN), identify a first uncertainty metric associated with the EVDL NN, the first uncertainty metric corresponding to the first input of the EVDL NN, calculate a first dissonance score based on the first uncertainty metric, and when the first dissonance score satisfies a threshold, assign the first predicted classification to the first input.

Example 2 includes the apparatus of example 1, wherein the processor circuitry is to when the first dissonance score does not satisfy the threshold calculate a second dissonance score based on the first dissonance score and the first predicted classification, calculate a summed dissonance score based on the first and second dissonance scores, and when the summed dissonance score satisfies the threshold, assign the first predicted classification to the first input.

Example 3 includes the apparatus of example 2, wherein the EVDL NN is a recurrent model.

Example 4 includes the apparatus of example 1, wherein the processor circuitry is to identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification, calculate a third dissonance score based on the second uncertainty metric, and when the third dissonance score satisfies the threshold, assign the second predicted classification to the second input.

Example 5 includes the apparatus of example 4, wherein the first input includes a first frame of a video and the second input includes a second frame of the video.

Example 6 includes the apparatus of example 5, wherein the first predicted classification corresponds to a first action in the first frame and the second predicted classification corresponds to a second action in the second frame, the first action different from the second action.

Example 7 includes the apparatus of example 1, wherein the EVDL NN is trained on second inputs, the second inputs different from the first input.

Example 8 includes the apparatus of example 1, wherein the first uncertainty metric is a Dirichlet distribution.

Example 9 includes the apparatus of example 8, wherein the Dirichlet distribution includes a simplex, the simplex including at least two vertices.

Example 10 includes the apparatus of example 9, wherein ones of the at least two vertices correspond to different predicted classifications.

Example 11 includes the apparatus of example 1, wherein the first dissonance score can include a value between 0 and 1.

Example 12 includes the apparatus of example 1, wherein the first dissonance score satisfies the threshold when the first dissonance score is less than the threshold.

Example 13 includes the apparatus of example 1, wherein the first predicted classification is determined by the EVDL NN.

Example 14 includes At least one non-transitory computer readable medium comprising instructions that, when executed, cause processor circuitry to at least receive a first predicted classification of a first input of an evidential deep learning neural network (EVDL NN), identify a first uncertainty metric associated with the EVDL NN, the first uncertainty metric corresponding to the first input of the EVDL NN, calculate a first dissonance score based on the first uncertainty metric, and assign the first predicted classification to the first input when the first dissonance score satisfies a threshold.

Example 15 includes the at least one non-transitory computer readable medium of example 14, wherein the processor circuitry is to when the first dissonance score does not satisfy the threshold calculate a second dissonance score based on the first dissonance score and the first predicted classification, calculate a summed dissonance score based on the first and second dissonance scores, and when the summed dissonance score satisfies the threshold, assign the first predicted classification to the first input.

Example 16 includes the at least one non-transitory computer readable medium of example 15, wherein the EVDL NN is a recurrent model comprising one or more stages, each stage having one or more predicted classifications.

Example 17 includes the at least one non-transitory computer readable medium of example 14, wherein the processor circuitry is to identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification, calculate a third dissonance score based on the second uncertainty metric, and when the third dissonance score satisfies the threshold, assign the second predicted classification to the second input.

Example 18 includes the at least one non-transitory computer readable medium of example 17, wherein the first input includes a first frame of a video and the second input includes a second frame of the video.

Example 19 includes the at least one non-transitory computer readable medium of example 18, wherein the first predicted classification corresponds to a first action in the first frame and the second predicted classification corresponds to a second action in the second frame, the first action different from the second action.

Example 20 includes the at least one non-transitory computer readable medium of example 14, wherein the EVDL NN is trained on second inputs, the second inputs different from the first input.

Example 21 includes the at least one non-transitory computer readable medium of example 14, wherein the first uncertainty metric is a Dirichlet distribution.

Example 22 includes the at least one non-transitory computer readable medium of example 21, wherein the Dirichlet distribution includes a simplex, the simplex including at least two vertices.

Example 23 includes the at least one non-transitory computer readable medium of example 22, wherein ones of the at least two vertices correspond to different predicted classifications.

Example 24 includes the at least one non-transitory computer readable medium of example 14, wherein the first dissonance score can include a value between 0 and 1.

Example 25 includes the at least one non-transitory computer readable medium of example 14, wherein the first dissonance score satisfies the threshold when the first dissonance score is less than the threshold.

Example 26 includes an apparatus comprising means for identifying to receive a first predicted classification of a first input of an evidential deep learning neural network (EVDL NN), and identify a first uncertainty metric associated with the EVDL NN, the first uncertainty metric corresponding to the first input of the EVDL NN, means for calculating a first dissonance score based on the first uncertainty metric, and means for assigning the first predicted classification to the first input when the first dissonance score satisfies a threshold.

Example 27 includes the apparatus of example 26, wherein when the first dissonance score does not satisfy the threshold the means for calculating is to calculate a second dissonance score based on the first dissonance score and the first predicted classification, calculate a summed dissonance score based on the first and second dissonance scores, and the means for assigning is to, when the summed dissonance score satisfies the threshold, assign the first predicted classification to the first input.

Example 28 includes the apparatus of example 27, wherein the EVDL NN is a recurrent model comprising one or more stages, each stage having one or more predicted classifications.

Example 29 includes the apparatus of example 26, wherein the means for identifying to identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification, the means for calculating to calculate a third dissonance score based on the second uncertainty metric, and the means for assigning is to, when the third dissonance score satisfies the threshold, assign the second predicted classification to the second input.

Example 30 includes the apparatus of example 29, wherein the first input includes a first frame of a video and the second input includes a second frame of the video.

Example 31 includes the apparatus of example 30, wherein the first predicted classification corresponds to a first action in the first frame and the second predicted classification corresponds to a second action in the second frame, the first action different from the second action.

Example 32 includes the apparatus of example 26, wherein the EVDL NN is trained on second inputs, the second inputs different from the first input.

Example 33 includes the apparatus of example 26, wherein the first uncertainty metric is a Dirichlet distribution.

Example 34 includes the apparatus of example 33, wherein the Dirichlet distribution includes a simplex, the simplex including at least two vertices.

Example 35 includes the apparatus of example 34, wherein ones of the at least two vertices correspond to different predicted classifications.

Example 36 includes the apparatus of example 26, wherein the first dissonance score can include a value between 0 and 1.

Example 37 includes the apparatus of example 26, wherein the first dissonance score satisfies the threshold when the first dissonance score is less than the threshold.

Example 38 includes a method comprising receiving a first predicted classification of a first input of an evidential deep learning neural network (EVDL NN), identifying a first uncertainty metric associated with the EVDL NN, the first uncertainty metric corresponding to the first input of the EVDL NN, calculating, by executing an instruction with at least one processor, a first dissonance score based on the first uncertainty metric, and assigning the first predicted classification to the first input when the first dissonance score satisfies a threshold.

Example 39 includes the method of example 38, further including when the first dissonance score does not satisfy the threshold calculating a second dissonance score based on the first dissonance score and the first predicted classification, calculating a summed dissonance score based on the first and second dissonance scores, and assigning the first predicted classification to the first input when the summed dissonance score satisfies the threshold.

Example 40 includes the method of example 38, wherein the EVDL NN is a recurrent model comprising one or more stages, each stage having one or more predicted classifications.

Example 41 includes the method of example 38, further including identifying a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification, calculating a third dissonance score based on the second uncertainty metric, and assigning the second predicted classification to the second input when the third dissonance score satisfies the threshold.

Example 42 includes the method of example 41, wherein the first input includes a first frame of a video and the second input includes a second frame of the video.

Example 43 includes the method of example 42, wherein the first predicted classification corresponds to a first action in the first frame and the second predicted classification corresponds to a second action in the second frame, the first action different from the second action.

Example 44 includes the method of example 38, wherein the EVDL NN is trained on second inputs, the second inputs different from the first input.

Example 45 includes the method of example 38, wherein the first uncertainty metric is a Dirichlet distribution.

Example 46 includes the method of example 45, wherein the Dirichlet distribution includes a simplex, the simplex including at least two vertices.

Example 47 includes the method of example 46, wherein ones of the at least two vertices correspond to different predicted classifications.

Example 48 includes the method of example 38, wherein the first dissonance score can include a value between 0 and 1.

Example 49 includes the method of example 38, wherein the first dissonance score satisfies the threshold when the first dissonance score is less than the threshold.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to at least one of instantiate or execute the machine readable instructions to:
receive a first predicted classification of a first input of an evidential deep learning neural network (EVDL NN);
identify a first uncertainty metric associated with the EVDL NN, the first uncertainty metric corresponding to the first input of the EVDL NN;
calculate a first dissonance score based on the first uncertainty metric; and
when the first dissonance score satisfies a threshold, assign the first predicted classification to the first input.

2. The apparatus of claim 1, wherein the processor circuitry is to:
when the first dissonance score does not satisfy the threshold:
calculate a second dissonance score based on the first dissonance score and the first predicted classification;
calculate a summed dissonance score based on the first and second dissonance scores; and
when the summed dissonance score satisfies the threshold, assign the first predicted classification to the first input.

3. The apparatus of claim 2, wherein the EVDL NN is a recurrent model comprising one or more stages, each stage having one or more predicted classifications.

4. The apparatus of claim 1, wherein the processor circuitry is to:
identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification;
calculate a third dissonance score based on the second uncertainty metric; and
when the third dissonance score satisfies the threshold, assign the second predicted classification to the second input.

5. The apparatus of claim 4, wherein the first input includes a first frame of a video and the second input includes a second frame of the video.

6. The apparatus of claim 5, wherein the first predicted classification corresponds to a first action in the first frame and the second predicted classification corresponds to a second action in the second frame, the first action different from the second action.

7. The apparatus of claim 1, wherein the EVDL NN is trained on second inputs, the second inputs different from the first input.

8. The apparatus of claim 1, wherein the first uncertainty metric is a Dirichlet distribution.

9. The apparatus of claim 8, wherein the Dirichlet distribution includes a simplex, the simplex including at least two vertices.

10. The apparatus of claim 9, wherein ones of the at least two vertices correspond to different predicted classifications.

11. The apparatus of claim 1, wherein the first dissonance score can include a value between 0 and 1.

12. The apparatus of claim 1, wherein the first dissonance score satisfies the threshold when the first dissonance score is less than the threshold.

13. The apparatus of claim 1, wherein the first predicted classification is determined by the EVDL NN.

14. At least one non-transitory computer readable medium comprising instructions that, when executed, cause processor circuitry to at least:
receive a first predicted classification of a first input of an evidential deep learning neural network (EVDL NN);
identify a first uncertainty metric associated with the EVDL NN, the first uncertainty metric corresponding to the first input of the EVDL NN;
calculate a first dissonance score based on the first uncertainty metric; and
assign the first predicted classification to the first input when the first dissonance score satisfies a threshold.

15. The at least one non-transitory computer readable medium of claim 14, wherein the processor circuitry is to:
when the first dissonance score does not satisfy the threshold:
calculate a second dissonance score based on the first dissonance score and the first predicted classification;
calculate a summed dissonance score based on the first and second dissonance scores; and
when the summed dissonance score satisfies the threshold, assign the first predicted classification to the first input.

16. (canceled)

17. The at least one non-transitory computer readable medium of claim 14, wherein the processor circuitry is to:
identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification;
calculate a third dissonance score based on the second uncertainty metric; and
when the third dissonance score satisfies the threshold, assign the second predicted classification to the second input.

18. The at least one non-transitory computer readable medium of claim 17, wherein the first input includes a first frame of a video and the second input includes a second frame of the video.

19. The at least one non-transitory computer readable medium of claim 18, wherein the first predicted classification corresponds to a first action in the first frame and the second predicted classification corresponds to a second action in the second frame, the first action different from the second action.

20. The at least one non-transitory computer readable medium of claim 14, wherein the EVDL NN is trained on second inputs, the second inputs different from the first input.

21. The at least one non-transitory computer readable medium of claim 14, wherein the first uncertainty metric is a Dirichlet distribution.

22.-25. (canceled)

26. An apparatus comprising:
means for identifying to:
receive a first predicted classification of a first input of an evidential deep learning neural network (EVDL NN); and
identify a first uncertainty metric associated with the EVDL NN, the first uncertainty metric corresponding to the first input of the EVDL NN;
means for calculating a first dissonance score based on the first uncertainty metric; and
means for assigning the first predicted classification to the first input when the first dissonance score satisfies a threshold.

27. The apparatus of claim 26, wherein:
when the first dissonance score does not satisfy the threshold:
the means for calculating is to:
calculate a second dissonance score based on the first dissonance score and the first predicted classification;
calculate a summed dissonance score based on the first and second dissonance scores; and
the means for assigning is to, when the summed dissonance score satisfies the threshold, assign the first predicted classification to the first input.

28. (canceled)

29. The apparatus of claim 26, wherein:
the means for identifying to identify a second uncertainty metric associated with the EVDL NN, the second uncertainty metric corresponding to a second input of the EVDL NN, the second input associated with a second predicted classification, the second predicted classification determined by the EVDL NN, the second predicted classification different from the first predicted classification;
the means for calculating to calculate a third dissonance score based on the second uncertainty metric; and
the means for assigning is to, when the third dissonance score satisfies the threshold, assign the second predicted classification to the second input.

30. The apparatus of claim 29, wherein the first input includes a first frame of a video and the second input includes a second frame of the video.

31. The apparatus of claim 30, wherein the first predicted classification corresponds to a first action in the first frame and the second predicted classification corresponds to a second action in the second frame, the first action different from the second action.

32.-49. (canceled)
